(19) United States
(12) Patent Application Publication
(10) Pub. No.: US 2022/0058371 A1
(43) Pub. Date: Feb. 24, 2022

(54) CLASSIFICATION OF CELL NUCLEI

(71) Applicant: Room4 Group Limited, Crowborough East Sussex (GB)

(72) Inventors: John Robert MADDISON, Crowborough East Sussex (GB); Håvard DANIELSEN, Oslo (NO)

(73) Assignee: Room4 Group Limited, Crowborough East Sussex (GB)

(21) Appl. No.: 17/413,451

(22) PCT Filed: Nov. 7, 2019
(86) PCT No.: PCT/EP2019/080590

§ 371 Date: Jun. 11, 2021

(30) Foreign Application Priority Data
Dec. 13, 2018 (GB) 1820361.2

(51) Int. Cl. G06K 9/00; G06K 9/62; G06N 20/00

(52) U.S. Cl. CPC G06K 9/00147; G06K 9/6256; G06K 9/628; G06K 2209/05; G06K 9/6263; G06K 9/6254; G06N 20/00; G06K 9/6277

(57) ABSTRACT

The present invention relates to a system that can be used to accurately classify objects in biological specimens. The user firstly classifies manually an initial set of images, which are used to train a classifier. The classifier then is run on a complete set of images, and outputs not merely the classification but the probability that each image is in a variety of classes. Images are then displayed, sorted not merely by the proposed class but also the likelihood that the image in fact belongs in a proposed alternative class. The user can then reclassify images as required.

### FIELD OF INVENTION

The invention relates to classification of cell nuclei automatically.

### BACKGROUND

Digital image analysis of cell nuclei is a useful method to obtain quantitative information from tissue. Typically a multiplicity of cell nuclei are required to perform meaningful analysis, as such there is motivation to develop an automatic system that can capture these cell nuclei from the original medium and gather a significant population of suitable nuclei for analysis.

The process to extract objects from an image taken from the preparation is called segmentation. Segmentation will typically yield artefacts, as well as target objects. Such artefacts may include objects that are not nuclei or are incorrectly segmented nuclei, both of which need to be rejected. Different types of cells will also be correctly extracted by the segmentation process, such as epithelial, lymphocytes, fibroblast and plasma cells. The different cell types also must be grouped together before analysis can be completed, as they may or may not be of interest to the analysis operation concerned depending on the function of the cell and the type of analysis considered.

Manual classification is subject to inter- and intra-observer variation, and can be prohibitively time consuming taking many hours to complete. There can be upwards of 5,000 objects in a small sample and 100,000 objects with larger samples. There is therefore a need to create a system that allows for the accurate automatic classification of objects within a system used for the analysis of cell nuclei.

It should be noted that the object classification in these systems may not be the end result, but just a step in allowing subsequent analysis of the objects to be completed. There are many methods that can be applied to generate a classifier in a supervised training system, where a predefined data set is used to train the system. Some are particularly unsuitable for inclusion in this type of system. For example neural network based systems that use the whole image, automatically determining the metrics to be used in the classification are not suitable, as they may include features in the classification scheme that have strong correlation with subsequently calculated metrics used to complete the analysis task. Other methods to generate a classification scheme include discriminate analysis and generation of decision trees such as OC1 and C45.

GB 2 486 398 describes such an object classification scheme which classifies individual nuclei into a plurality of types of nuclei by using a first binary boosting classifier to classify the individual nuclei in a first class and by using a second binary boosting classifier to classify those individual nuclei not classified into the first class by the first binary boosting classifier into a second class. By cascading algorithms, object classification is improved.

The method proposed by GB 2 486 398 involves a significant amount of user input in the training process to classify objects to allow the training of the classifiers to take place. This applies more generally to any object classification system as these all need training input.

The manual classification of objects to create the training database is relatively straightforward for small numbers of objects but creates difficulty in the case that a large number of objects are part of the training database. There is therefore a need for an object classification scheme which can provides an improvement to the classification scheme of GB 2 486 398 when dealing with training databases with large numbers of objects.

### SUMMARY OF INVENTION

According to the invention, there is provided an object classifier according to claim 1.

By training a first classifier step on only some of the initial set of images, then classifying a complete set of images, displaying the complete set, sorted by likelihood that the images may be in a potential alternative class, and then allowing further user input to refine the classification, the method can cope with much greater numbers of input images for the same amount of user input than the method proposed in GB 2 486 398.

By retraining the classification algorithm using the final class and the plurality of classification parameters of each of the complete set of images, there results a classification algorithm trained on a large set of input images.

Alternatively, the classified images can additionally be directly processed further, and hence the method may further comprise carrying out further analysis on images of the set of images having one or more of the final classes. Thus, the method may further comprise calculating a further optical parameter for images of the set of images being in a selected one or more of the final classes.

Alternatively or additionally to calculating a further optical parameter, the method may further comprise carrying out case stratification, for example by analysing the classified nuclei for features related to different stages of cancer or other diseases. The inventors have discovered that the use of the proposed method of classifying the images leads to improved case stratification. The output of the case stratification may be used by a medical practioner for example to improve diagnosis or to determine prognosis.

The classification algorithm may be an algorithm adapted to output a set of respective probabilities that an image represents an example of each respective class. The classification algorithm may be an ensemble learning method for classification or regression that operates by constructing a multitude of decision trees at training time and outputting the class that is the mode of the classes in the case of classification or mean prediction in the case of regression) of the individual trees.

The plurality of classification parameters may include a plurality of parameters selected from: Area, optical density, Major Axis Length, Minor Axis Length, Form Factor, Shape Factor, Eccentricity, Convex area, Concavity, Equivalent Diameter, Perimeter, Perimeterdev, Symmetry, Hu moments of the shape, Hu moments of the image within the shape, Hu moments of the whole image, Mean intensity within the shape, standard deviation of intensity within the shape, variance of intensity within the shape, skewness of intensity within the shape, kurtosis of intensity within the mask, coefficient of variation of intensity within the shape, mean intensity of whole area, standard deviation of intensity of whole area, variance of intensity in the whole area, kurtosis of intensity within whole area, border mean of shape, mean of intensity of the of the strip five pixels wide just outside the border of the mask, standard deviation of intensity of the strip five pixels wide just outside the border of the mask, variance of intensity of the strip five pixels wide just outside the border of the mask, skewness of intensity of the strip five pixels wide just outside the border of the mask, kurtosis of intensity of the strip five pixels wide just outside the border of the mask; coefficient of variation of intensity of the strip five pixels wide just outside the border of the mask, jaggedness, variance of the radius, minimum diameter, maximum diameter, number of gray levels in the object, angular change, and standard deviation of intensity of the image after applying a Gabor filter.

The inventors have discovered that these parameters give good classification results when combined with suitable classification algorithms such as tree-based classifiers.

The plurality of parameters may in particular include at least five of the said parameters, for example all of the said parameters. In some cases, for some types of classification, it may be possible to use fewer than all of the parameters and still get good results.

The user interface may have a control for selecting the potential alternative class when displayed images of nuclei of the likely class.

The method may further comprise capturing the image of cell nuclei by photographing a monolayer or section on a microscope.

In another aspect, the invention relates to a computer program product comprising computer program code means adapted to cause a computer to carry out a method as set out above when said computer program code means is run on the computer.

The computer is adapted to carry out a method as set out above to classify images of cell nuclei into a plurality of classes.

In another aspect, the invention relates to a system comprising a computer and a user interface, wherein:
the computer comprises code for calculating a plurality of classification parameters characterising the image and/or the shapes of the individual nuclei of the initial training set of images, training a classification algorithm using the user-selected class and the plurality of classification parameters of the initial training set of images, and running the trained classification algorithm on each of the set of images to output a set of probabilities that each of the set of images are in each of the plurality of classes; and
the user interface includes
a selection control for accepting user input classifying each of an initial training set of images taken from the set of images of cell nuclei into a user-selected class among the plurality of classes;
a display area for outputting on the user interface images of cell nuclei of the set of images which the set of probabilities indicates are in a likely class of the plurality of classes and also have a potential alternative class being a different class to the likely class of the plurality of classes;
a selection control for accepting user input to select images out of the output images that should be reclassified to the potential alternative class; to obtain a final class for each of the set of images.

### BRIEF DESCRIPTION OF DRAWINGS

For a better understanding of the invention, embodiments will now be described, purely by way of example, with reference to the accompanying drawings, in which

FIG. 1 shows a system according to a first embodiment of the invention;

FIG. 2 is a flow chart of a method according to an embodiment of the invention;

FIG. 3 is an example user interface output after step 220;

FIG. 4 is an example user interface output at step 270; and

FIG. 5 is an example user interface output at step 270.

### DETAILED DESCRIPTION

### The System

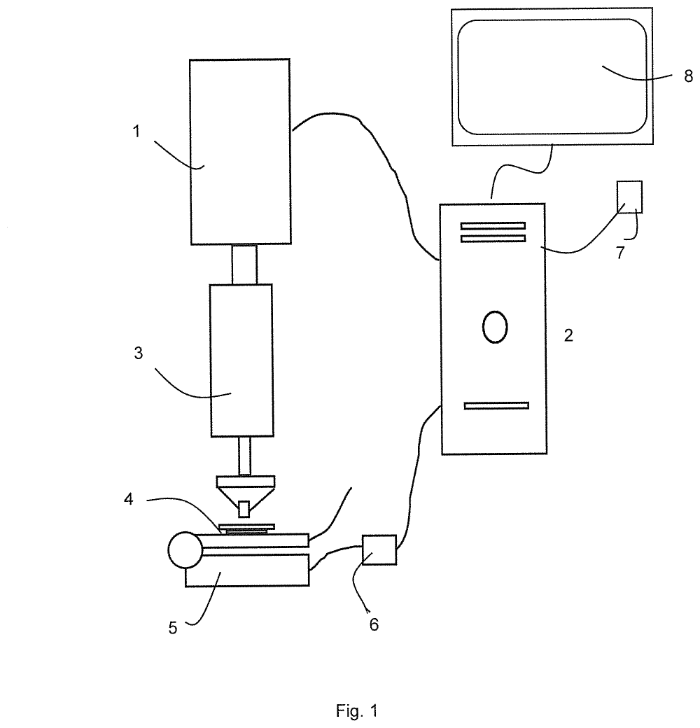

Images may be captured using the components shown in FIG. 1 include camera 1 positioned on the microscope 3 which is used to analyse the specimen 4. An automated stage 5 and associated controller 6 are used to move the sample around all being controlled by the computer 2. The computer 2 moves the specimen automatically and the camera 1 is used to capture images of the specimen, including cell nuclei.

As an alternative or additionally to capturing images of specimens using the components shown in FIG. 1, the method may also work with images captured in a different way. For example, images may be captured from a slide scanner. In other cases, sets of images may be available which have already been captured and the method may classify such images.

Indeed, the method of the invention is not reliant on the images all been captured in the same way on the same apparatus and is able to cope with large numbers of images obtained from a variety of sources.

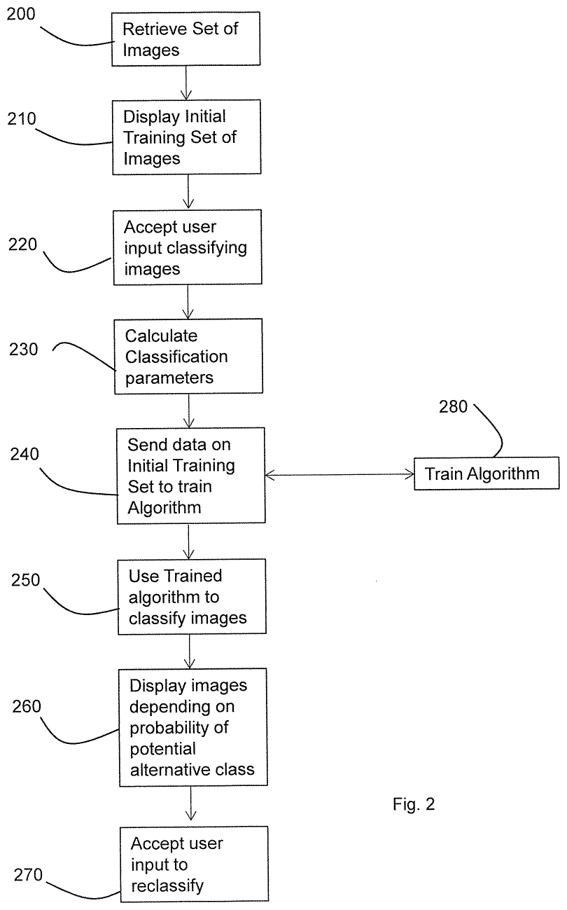

The processing of these images is then carried out in accordance with the method illustrated in FIG. 2.

The set of images are then passed to the computer 2 which segments them, i.e. identifies the individual nuclei. A number of parameters, shown in Table 1 below, are then calculated for each of the masks.

A user then uses the system shown in FIG. 1 using the method illustrated in FIG. 2 to classify some examples of the set of images of the cell nuclei into specific classes, which will also be referred to as galleries, for example Epithelial, lymphocytes, plasma cells and artefacts. For example, these can be placed into class 1, class 2, class 3 and class 4 respectively.

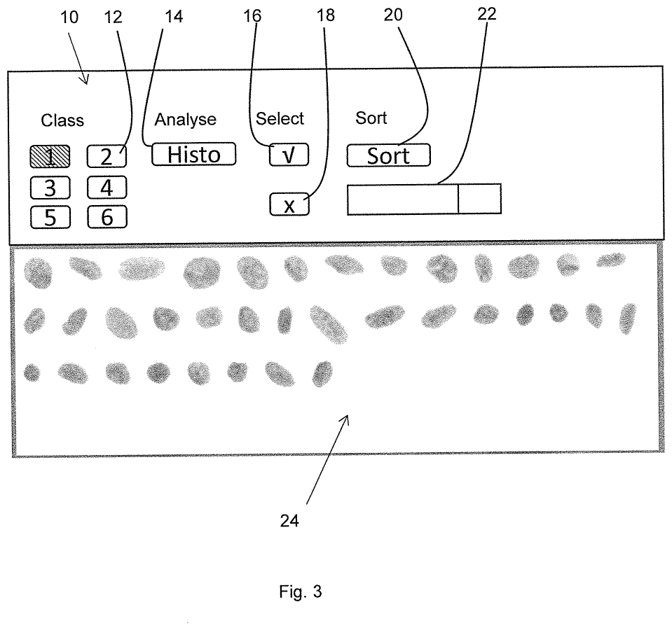

The images are retrieved (Step 200) and displayed (Step 210) on user interface 7,8 which includes a screen 7 and a pointer controller such as mouse 8. The user can then (Step 220) sort the objects by ordering them by the parameters listed in Table 1, the objects can then be selected and moved to a relevant class, either one at time or by selecting using the rubber band technique. An example screen of images in nuclei display area 24 sorted into class 1 (indicated by the selected class selection control 12 labelled 1) is shown in FIG. 3. This selection by the user groups the objects into groups so that the classifier can be trained. This user-grouped set of images will be referred to as the initial training set of images and each of the initial training set of images is assigned to a user-selected class. The initial training set of images may be 0.1% to 50% of the images, for example 5% to 20%.

The user interface screen 7 includes a nuclei display area 24 and number of controls 10. “Class selection” control 12 allow the selection of individual classes, to display the nuclei from those classes. An “Analyze” control 14 generates a histogram (of intensity) of a selected nucleus or nuclei. A select control 16 switches into a mode where selecting a nucleus with the mouse selects that nucleus, and a deselect control 18 switches into a mode where selecting a nucleus with the mouse deselects that nucleus. By the use of these controls the user can select a number of nuclei. These can then be dragged into a different class by dragging to the respective class selection control 12.

Note that in some cases the user may be able to classify an image by eye. In alternative cases, the user may select an image and the user interface screen may respond by presenting further data relating to the image to assist the user in classifying the image.

The user interface screen 7 also includes a sort control 20,22. This may be used to sort the images of nuclei of one class by the probability that the image is in a different class at a later stage of the method. In the example of FIG. 3, the displayed nuclei are simply nuclei in class 1 not sorted by any additional probability. This represents the display of the nuclei in class 1 after the user has carried out the sorting.

It is not necessary for the user in this initial step to classify more than a fraction of the complete set of images.

Next, the method uses a classification approach to classify the other images that have not been classified by the user. A number of classification parameters are calculated (Step 230) for each of the images classified by the user.

The classification approach uses a number of parameters, which will be referred to as classification parameters. In the particular arrangement, the following classification parameters are calculated for each image. It will be appreciated that although the following list gives goad results in the specific area of interest, other sets of selection parameters may be used where appropriate. In particular, it is not necessary to calculate all parameters for all applications—in some cases a more limited set of parameters may give results that are effectively as good.

TABLE 1
Calculated Parameters

| Parameter | Description |
|---|---|
| Area | Number of pixels within the mask |
| OD | $O D = - log ( \frac{M e a n l n t e n s {ity}_{im}}{M e a n l n t e n s {itν}_{bk}} )$ |
| | Where Optical Density is OD. MeanIntensityᵢₘ is the mean intensity of the |
| | segmented object and Meanlntensity_{bk} is the mean intensity of the |
| | background area. |
| Major Axis | minor axis = \sqrt{(a + b)² − ƒ} |
| Length | |
| Minor Axis | major axis = a + b |
| Length | |
| Form Factor | $FormFactor = \frac{D i {ameter}_{max}}{{Diameter}_{min}}$ |
| | Form factor is the measure used to describe the shape in terms of the |
| | length of its minimum and maximum diameters, as opposed to shape |
| | factor in Section 3.2.3 which references object to a circle using perimeter |
| | and area measures. Diameterₘᵢₙ and Diameterₘₐₓ are the minimum and |
| | maximum diameters of the segmented cell. |
| Shape Factor | $ShapeFactor = 2 \cdot ( \frac{A r e a}{Perimeter \text{·} ( \frac{{Diameter}_{max}}{2} )} )$ |
| | Shape factor is a parametric measure used to describe the circularity of |
| | an object where shape factor for a circle = 1. Area, Perimeter and |
| | Diameter are object dimensions in pixels. |
| Eccentricity | The eccentricity is the ratio of the distance between the foci of the ellipse |
| | and its major axis length. |
| Convex area | The area defined by the convex hull of the object, area within the outside |
| | contour. |
| Concavity | $Concavity = \frac{C o n v e x H u l {l}_{A r e a}}{M a s {k}_{Area}}$ |
| | Concavity is the area difference between the true area and that of a |
| | convex hull of the perimeter. This parametric measure is used to detect |
| | touching nuclei. ConvexHull_{Area} is the area defined by the convex hull of |
| | the object and Mask_{Are} is the area of the segmented object. This |
| | parametric measure can be used to determine if an object comprises of |
| | two touching nuclei. |
| Equivalent | The equivalent diameter circle that has the same perimeter as the object. |
| Diameter | |
| Perimeter | P = 1.41.N_{Diagonal}_Pixels + N_{Vert}_Hoz_Pixels |
| | Perimeter P is the number of boundary pixels in the segmented object. |
| | N_{DiagonalPixels} is the number of pixel on the perimeter of the object |
| | diagonally connected to neighbours and N_{Vert}_Hoz_Pixels is the number of |
| | pixels connected to neighbouring pixels either vertically or horizontally. |
| Perimeterdev | Standard deviation of the distance between the centroid of the object and |
| | the points on the perimeter |
| Symmetry | Symmetry is used to detect uneven of cut |
| | $Symmetry = ( \frac{{\sum }_{n = i}^{N} \sqrt{{( {X}_{n 1} - {X}_{n 2} )}^{2}}}{N} )$ |
| | cells or cells that are touching each other. Xₙ₁ and Xₙ₂ are vector pairs, π |
| | radians around the perimeter of the object with the centroid at the centre |
| | There are N equally spaced paired vectors. |
| HU Parameters | Seven Hu Moments are calculated as described in |
| Calculated On | http://en.wikipedia.org/wiki/Image moment. The Hu moments are a set |
| The Mask | of parameters that describe an object are calculated on the masked |
| | object. |
| | Spatial moment calculated as |
| | Mⱼᵢ = sum_{x,y}(I(x,y)· x^{j} · yⁱ) |
| | where I(x,y) is the intensity of the pixel (x, y) |
| | From which the central moment is calculated |
| | μᵢⱼ = sum_{x,y}(I(x,y) · (x − x_{c})^{J} · (y − y_{c})ⁱ), |
| | where x_{c} = M₁₀/M₀₀, y_{c} = M₀₁/M₀₀ - coordinates of the gravity center |
| | And the normalised central moment |
| | nᵢⱼ = μᵢⱼ/M₀₀^{((i+j)/2+1)} |
| | From which the seven Hu Moments are calculated |
| | h₁ = η₂₀ + η₀₂ |
| | h₂ = (η₂₀ − η₀₂)² 4η₁₁² |
| | h₃ = (η₃₀ − 3η₁₂)² + (3η₂₁ − η₀₃)² |
| | h₄ = (η₃₀ + η₁₂)² + (η₂₁ + η₀₃)² |
| | h₅ = (η₃₀ −3η₁₂)(η₃₀ + η₁₂)[(η₃₀ + η₁₂)² − 3(η₂₁ + η₀₃)²] + (3η_{21 -} |
| | η₀₃)(η₂₁ + η₀₃)[3(η₃₀ + η₁₂)² − (η₂₁ η₀₃)²] |
| | h₆ = (η₂₀ − η₀₂)[(η₃₀ + η₁₂)² − (η₂₁ + η₀₃)²] + 4η₁₁(η₃₀ + η₁₂)(η₂₁ + η₀₃) |
| | h₇ = (3η₂₁ − η₀₃)(η₂₁ + η₀₃)[3(η₃₀ + η₁₂)² − (η₂₁ + η₀₃)²] − (η₃₀ − |
| | 3η₁₂)(η₂₁ + η₀₃)[3(η₃₀ + η₁₂)² − (η₂₁ + η₀₃)²] |
| | These values are proved to be invariants to the image scale, rotation, |
| | and reflection except the seventh one, whose sign is changed by |
| | reflection. |
| HU Parameters | Same calculation as HU Parameters Calculated On The Mask but on the |
| Calculated On | pixel values of the object within the mask |
| The Gray Scale | |
| Image Within The | |
| Mask(GS) | |
| HU Parameters | Same calculation as HU Parameters Calculated On The Mask but on the |
| Calculated On | whole masked object |
| The Gray Scale | |
| Image On The | |
| Whole | |
| Image(GS) | |
| Mean Within The Mask | ${\overline{Intensity}}_{im} = \frac{{\sum }_{n = 0}^{n = {N}_{im}} l n t e {nsity}_{n}}{{N}_{i m}}$ |
| | I̅n̅t̅e̅n̅s̅i̅t̅y̅ᵢₘ is the mean intensity inside a segmented area and Nᵢₘ is the |
| | number of pixels within the object, Intensity n is the pixel intensity for |
| | individual pixels. |
| Stddev Within_{The Mask} | $σ = \sqrt{\frac{{\sum }_{l = 1}^{N} {( {x}_{i} - \overline{x} )}^{2}}{N}}$ |
| | Standard deviation is σ, where x̅ is the mean value, xᵢ the sample value |
| | and N the number of samples. |
| Variance Within | var = σ² |
| The Mask | |
| Skewness Within The Mask | $skew = \frac{\sum {( X - x )}^{3}}{N {σ}^{3}}$ |
| | Skew is γ₁, where x̅ is the mean value, xᵢ the sample value and N the |
| | number of samples, N the number of samples, σ the standard deviation. |
| | The measure shows the distribution of the histogram. |
| Kurtosis Within The Mask | ${γ}_{2} = \frac{{\sum }_{i = 1}^{N} {( {x}_{i} - \overline{x} )}^{4}}{N \cdot {σ}^{4}} - 3$ |
| | Skew is γ₂, where x̅ is the mean value, xᵢ the sample value and N the |
| | number of samples, N the number of samples, σ the standard deviation. |
| | The measure shows the degree of peakedness of the distribution. |
| Cv Within The | Stddev/mean |
| Mask | |
| Mean Of Whole | As for within the mask |
| Area | |
| Stddev Of Whole | As for within the mask |
| Area | |
| Variance Of | As for within the mask |
| Whole Area | |
| Skewness Of | As for within the mask |
| Whole Area | |
| Kurtosis Of | As for within the mask |
| Whole Area | |
| Cv (coefficient of | As for within the mask |
| variation) of | |
| the Whole Area | |
| Border Mean | As above but for the 5 pixels outside the border of the mask |
| Border Stddev | As above but for the 5 pixels outside the border of the mask |
| Border Variance | As above but for the 5 pixels outside the border of the mask |
| Border Skewness | As above but for the 5 pixels outside the border of the mask |
| Border Kurtosis | As above but for the 5 pixels outside the border of the mask |
| Border CV | As above but for the 5 pixels outside the border of the mask |
| Jaggedness | $Jaggedness = ( \frac{{\sum }_{n = 0}^{n = N} \sqrt{{( {X}_{n} - ( \frac{median ( {X}_{( n - n + 5 )} )}{5} ) )}^{2}}}{N} )$ |
| | Jaggedness is the measure of the roughness of the object. By calculating |
| | local differences in radial distance, this measure can be used to detect |
| | cut nuclei or to distinguish artefacts from nuclei that are of interest. Xₙ is |
| | the distance from the perimeter to the centroid of the object. |
| Radius variance | $RadialVariance = ( \frac{{\sum }_{n = 1}^{N} \sqrt{{( {x}_{i} - \overline{x} )}^{2}}}{N} )$ |
| | Radial variance is the parametric measure used to determine how much |
| | the radial distance deviates around the perimeter of the measure nuclei. |
| | xᵢ is the distance from the perimeter to the centroid of the object and x̅ |
| | is the mean radius. |
| Mindiameter | Minimum distance from the centroid to the edge of the mask |
| Maxdiameter | Minimum distance from the centroid to the edge of the mask |
| Gray Levels In | Number of gray levels in the object |
| The Object | |
| Angular change | AngularChange = Max_{a,} |
| Gabor Filter | Standard deviation of the image once Gabor filters as described |
| Calculations | http://en.wikipedia.org/wiki/Gabor filter has been calculated. |

Then, the algorithm is trained using the classification parameters for each of the initial training set of images. Data on the images, i.e. the classification parameters and the user-selected class are sent (step 240) to an algorithm to be trained (step 280).

Any suitable classification algorithm may be used. The classification algorithm needs not to simply output a proposed classification, but instead output a measure of the probability of each image fitting into each available class as a function of the classification parameters.

A particularly suitable type of algorithm is an ensemble learning method for classification or regression that operates by constructing a multitude of decision trees at training time and outputting the class that is the mode of the classes in the case of classification or mean prediction in the case of regression) of the individual trees. Such an algorithm calculating a set of decision trees may be based on the paper by Tim Kam Ho, IEEE Transactions on Pattern Analysis and Machine Intelligence (Volume: 20, Issue: 8, August 1998), and developments thereof may be used.

In particular, classification algorithms sometimes referred to as “XG Boost” or “Random Forest” may be used. In the examples in this case, the algorithms used were those available at httpsJ/cran.r-project.org/web/packages/randomForest/randomForest.pdf and in the alternative httpsJ/cran.r-project.org/web/packages/xgboost/xgboost.pdf.

The output of these algorithms is, for each of the set of images, a probability that each of the images represents an example of each class. For example, in the case that there are six classes, the set of probabilities of a sample image may be (0.15,0.04,0.11,0.26,0.11,0.33), in which the numbers represent the probability that the sample image is in the first, second, third, fourth, fifth and sixth class respectively. In this example, the highest probability is that the sample image is in the sixth class and so the sample image is classified into that class.

At this stage of the method, the classification parameters and the user-selected class of the initial training set of images is used to train the classification algorithm.

Then, the algorithm is run (Step 250) on the complete set of images, not just the initial training set of images, or alternatively on just those images that are not part of the initial training set, to classify each of the images.

These images are then displayed (step 260) not merely on the basis of the chosen sample class but also on the basis of the likelihood that the image is in a different class. Thus, the images may b displayed in groups determined not merely by the classification of the image but also the probability that the image may be in another class.

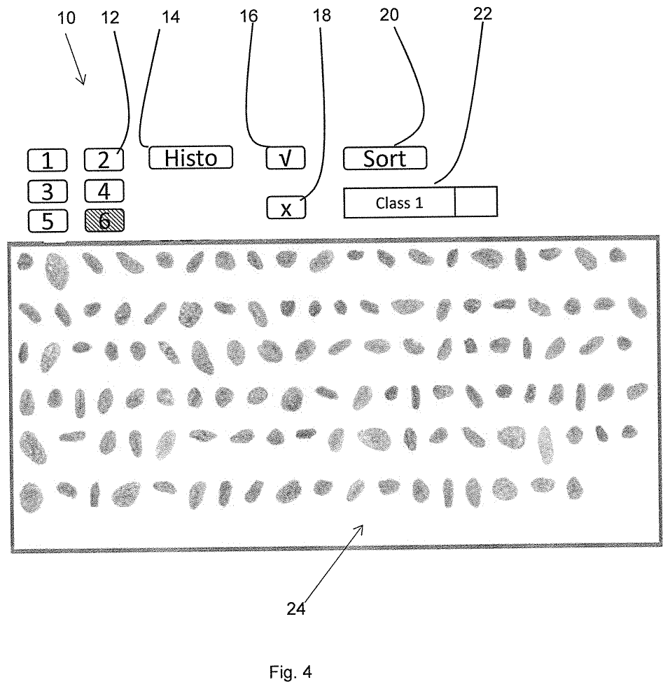

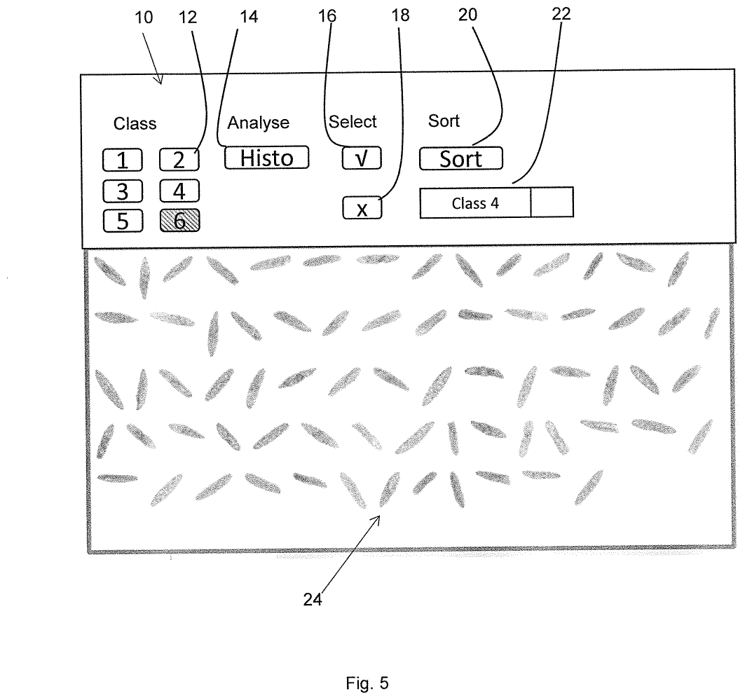

For example, as illustrated in FIG. 4 the user is presented with a page of the images in the sixth class most likely to be in the first class. As illustrated in FIG. 5, a different page illustrates the images in the sixth class most likely to be in the fourth class. This alternative class will be referred to as a proposed alternative class. Note that the shapes of nuclei are of course different in FIG. 5 as these represent closer matches to a different class of nuclei.

The user may select the displays represented in FIGS. 4 and 5 using the sort control 20 and sort selector 22. Thus, the user displays class 6 by selecting the corresponding class selection control 12, and then selects to sort by class 1 (i.e. the probability of class 1) by selecting class 1 in sort selector 22 and then pressing the sort control 20, to obtain the set of images of FIG. 4. The set of images of FIG. 5 are obtained in a similar way except by selecting class 4 in the sort selector 22.

The user can then review these pages of images and reclassify quickly and easily select and reclassify those images that should be in the proposed alternative class (step 270).

This leads to a set of images that have been reviewed by the human user without the need for individually reclassifying every image.

At this stage, the reviewed classification of the image set can be used for further analysis. This is appropriate if what is required is a set of images for analysis. Such analysis may include calculating a further optical parameter from each of a particular class of images, i.e. each of the images in one of the classes. Such calculation of the further optical parameter can include calculating optical density, calculating integrated optical density, or calculating pixel level measures such as texture, and/or including calculating measures of some property of the cell, such as the biological cell type or other biological characteristic.

Alternatively, at this stage, the classification algorithm can be retrained using the classification parameters of all of the images (by rerunning step 280 with the complete data set) and the class assigned to those images after review by the human user. In the example, the same classification algorithm as was trained using the initial training set of data. Alternatively, another algorithm may be used.

This leads to a trained classification algorithm that is effectively trained on the complete set of images without the user having had to manually classify each of the set of images. This means that it is possible to use much larger training data sets and hence to provide a more accurate and reliable trained classification algorithm.

The inventors have discovered that this approach works particularly well with some or all of the set of classification indicia proposed.

The resulting trained classification algorithm may be trained with greater quantities of data and hence is in general terms more reliable. Therefore, the trained algorithm may create a better automatic classifier of images, which can be extremely important in medical applications. Accurate classification of images of nuclei is a critical step, for example in evaluating cancer in patients, as the different susceptibility of different types of nuclei to different types of cancer means that it is necessary to have accurately classified nuclei to achieve accurate diagnosis. Such accurate classification and diagnosis may in turn allow for patients to be treated appropriately for their illness, for example only using chemotherapy where treating the exact type of cancer with chemotherapy has been shown to give enhanced life outcomes. This does not just apply to cancer, but to any medical test requiring the use of classified images of nuclei.

The utility of the larger dataset for training is that it allows for the training set to included rare biological events such as small sub population cells with certain characteristic so that these rare cells can be more reliably and statistically relied upon and hence trained into the system. It also allows rapid retraining of a system where there have been small changes in the biological specimen, preparation or imaging system that cause the existing classifier to require refinement.

1. A method of classifying a set of images of cell nuclei into a plurality of classes, comprising:
accepting input classifying each of an initial training set of images taken from the set of images of cell nuclei into a user-selected class among the plurality of classes;
calculating a plurality of classification parameters characterising the image and/or the shapes of the individual nuclei of the initial training set of images;
training a classification algorithm using the user-selected class and the plurality of classification parameters of the initial training set of images;
running the trained classification algorithm on each of the set of images to output a set of probabilities that each of the set of images are in each of the plurality of classes;
outputting on a user interface images of cell nuclei of the set of images which the set of probabilities indicates are in a likely class of the plurality of classes and also have a potential alternative class being a different class to the likely class of the plurality of classes;
accepting user input to select images out of the output images that should be reclassified to the potential alternative class to obtain a final class for each of the set of images; and
retraining the classification algorithm using the final class and the plurality of classification parameters of each of the complete set of images.

2. A method according to claim 1 further comprising:
calculating at least one further optical parameter for images of a set of images being in a selected one or more of the final classes.

3. A method according to claim 1 further comprising carrying out case stratification on images of a set of images being in a selected one or more of the final classes.

4. A method according to claim 1 wherein the classification algorithm is an ensemble learning method for classification or regression that operates by constructing a multitude of decision trees at training time and outputting the class that is the mode of the classes in the case of classification or mean prediction in the case of regression) of the individual trees.

5. A method according to claim 1 wherein the plurality of classification parameters include a plurality of parameters selected from: Area, optical density, Major Axis Length, Minor Axis Length, Form Factor, Shape Factor, Eccentricity, Convex area, Concavity, Equivalent Diameter, Perimeter, Perimeterdev, Symmetry, Hu moments of the shape, Hu moments of the image within the shape, Hu moments of the whole image, Mean intensity within the shape, standard deviation of intensity within the shape, variance of intensity within the shape, skewness of intensity within the shape, kurtosis of intensity within the mask, coefficient of variation of intensity within the shape, mean intensity of whole area, standard deviation of intensity of whole area, variance of intensity in the whole area, kurtosis of intensity within whole area, border mean of shape, mean of intensity of the of the strip five pixels wide just outside the border of the mask, standard deviation of intensity of the strip five pixels wide just outside the border of the mask, variance of intensity of the strip five pixels wide just outside the border of the mask, skewness of intensity of the strip five pixels wide just outside the border of the mask, kurtosis of intensity of the strip five pixels wide just outside the border of the mask; coefficient of variation of intensity of the strip five pixels wide just outside the border of the mask, jaggedness, variance of the radius, minimum diameter, maximum diameter, number of gray levels in the object, angular change, and standard deviation of intensity of the image after applying a Gabor filter.

6. A method according to claim 5 wherein the plurality of parameters include at least five of the said parameters.

7. A method according to claim 5 wherein the plurality of parameters includes all of the said parameters.

8. A method according to claim 1 wherein the user interface has a control for selecting the potential alternative class when displayed images of nuclei of the likely class.

9. A method according to claim 1 further comprising capturing the image of cell nuclei by photographing a monolayer or section on a microscope.

10. A computer program product comprising computer program code means adapted to cause a computer to carry out a method according to claim 1 when said computer program code means is run on the computer.

11. A system comprising a computer and a means for capturing images of cell nuclei,
wherein the computer is adapted to carry out a method according to claim 1 to classify images of cell nuclei into a plurality of classes.

12. A system comprising a computer and a user interface, wherein:
the computer comprises code for calculating a plurality of classification parameters characterising the image and/or the shapes of the individual nuclei of the initial training set of images, training a classification algorithm using the user-selected class and the plurality of classification parameters of the initial training set of images, and running the trained classification algorithm on each of the set of images to output a set of probabilities that each of the set of images are in each of the plurality of classes; and
the user interface includes
a selection control for accepting user input classifying each of an initial training set of images taken from the set of images of cell nuclei into a user-selected class among the plurality of classes;
a display area for outputting on the user interface images of cell nuclei of the set of images which the set of probabilities indicates are in a likely class of the plurality of classes and also have a potential alternative class being a different class to the likely class of the plurality of classes;
a selection control for accepting user input to select images out of the output images that should be reclassified to the potential alternative class to obtain a final class for each of the set of images;
wherein the computer system further comprises code for retraining the classification algorithm using the final class and the plurality of classification parameters of each of the complete set of images.

13. A system according to claim 12 wherein the classification algorithm is an algorithm adapted to output a set of respective probabilities that an image represents an example of each respective class.

14. A system according to claim 12 wherein the user interface has a control for selecting the potential alternative class when displayed images of nuclei of the likely class.
